(19) United States
(12) Patent Application Publication
(10) Pub. No.: US 2004/0048658 A1
(43) Pub. Date: Mar. 11, 2004

(54) System and method for awarding credits based upon arcade game play

(76) Inventor: Michael K. Sanders, Mt. Pledsant, SC (US)

Correspondence Address: MCNAIR LAW FIRM, P.O. BOX 10827, GREENVILLE, SC, 29603-0827, US

(21) Appl. No.: 10/395,357

(22) Filed: Mar. 24, 2003

Related U.S. Application Data
(60) Provisional application No. 60/366,904, filed on Mar. 22, 2002.

(51) Int. Cl. A63F 13/00; A63F 9/24

(52) U.S. Cl. 463/25

(57) ABSTRACT

A system and method are disclosed for allowing an arcade game player to be rewarded for playing the arcade game in a form other than cash. The player is provided with a player card having a readable and writable medium thereon for recording credits. Credits are deducted from or added to the player card according to the play of the arcade game. After a player has played the game, the net credits on the player card are then converted to a non-arcade credit value on a merchant card, allowing the player to use the merchant card to purchase goods and services at merchant locations accepting the merchant card. The system and method permit converting existing arcade games such that the system and method can be also used on existing games.

### CROSS REFERENCE TO RELATED APPLICATION

Applicant claims the benefit of priority under Title 35, United States Code, §119(a)-(d) of U.S. Provisional Application No. 60/366,904, filed Mar. 22, 2002.

### FIELD OF THE INVENTION

This invention relates to a system and method for providing a means for recording and using rewards derived from playing arcade games, and more specifically, to a system and method for allowing a player to benefit from game credits awarded from an arcade game in a form widely accepted by consumer merchants.

### BACKGROUND OF THE INVENTION

It has become quite popular for individuals to enjoy arcade games as a pastime. With the advent of technology, arcade games are taking a multitude of forms and are even available on the Internet. Traditionally, arcade games require the input of currency or credits from the player to generate game credits allowing the player to play the game. The player spends the game credits to play the game. Based upon skill, chance, or both, the player is awarded points or credits according to the rules of the game. At the end of the game, the successful player has a total number of points or credits that can be recorded in a multitude of fashions. For example, the player may be shown a high-score board, the points can aggregate from previous games, or the player's outcome can translate directly into a monetary payoff in a manner similar to the well-known slot machine. Many states, however, have laws that prohibit playing or benefiting from playing arcade games that provide cash rewards directly to the player. As arcade games now exist, winnings must be either taken in cash from the machine or taken in cash from the cashier where they exchange game credits, recorded through some means, for cash. There is a need to allow a player to play arcade games and take advantage of the outcome of the played game without having the outcome rewarding the player with cash. It is also desirable to have a relatively secure means for rewarding a player such that, even where permissible, a player need not take a reward in the form of cash.

In gaming establishments, such as casinos or the like, a large number of game terminals are placed throughout the establishment. Players of the game terminals select the game terminal that they wish to play and either obtain currency or tokens from a roving change clerk or use the currency or tokens or other credits otherwise obtained. These credits or tokens are provided to the game and “spent” as each game is played. If the particular game only rewards the player with game credits, the player can only use the rewards to play more games. While this is an acceptable outcome for some players, others will not play under these conditions. At the same time, it is of course desirable to ensure that the playing of the games, and the receipt of a reward therefore, complies with all applicable laws. To increase the attractiveness of the games to the player, and to enhance the return of investment by those who provide the games and gaming machines, it is desirable to provide a means by which players may receive usable, legal rewards for successful play.

Accordingly, it is a purpose of this invention to allow a player to receive the benefit or results of the played game without having the results being a monetary reward.

It is another objection of the invention to reward the player for playing the game with a means acceptable at a multitude of commercial vendors without being cash.

It is still another object of the invention to provide a means to retrofit existing currency arcade games with this invention.

### SUMMARY OF THE INVENTION

These and other objectives are accomplished by providing a system for rewarding a player of an arcade game. The system comprises a player card having a computer readable player card medium representing arcade game credits for actuating the arcade game. A player card interface is included for receiving the player card. The player card interface is adapted for reading the computer readable player card medium representing the arcade game credits. A prime computer readable medium is provided in communication with the player card interface. A set of computer readable instructions is embodied in the prime computer readable medium for reading the player card medium with the player card interface, determining the arcade game credits represented by the player card according to the player card medium, determining a non-arcade credit value corresponding to the arcade game credits, and, associating the non-arcade credit value with a merchant card so that the player can transfer arcade game credits into non-arcade credit values.

In a further advantageous embodiment, the set of computer readable instructions include instructions for determining whether the player card represents sufficient arcade game credits for actuating the arcade game. Also, the set of computer readable instructions include instructions for reducing the number of credits represented by the player card by a predetermined number upon actuation of the arcade game for play. Further, the set of computer readable instructions include instructions for increasing the number of credits represented by the player card by a predetermined amount according to the game play.

In a particularly advantageous embodiment, the set of computer readable instructions include instructions for directing the player card interface to write to the computer readable player card medium so that the arcade game credits can be added to the player card. However, the arcade game credits may alternatively be held in a database associated with information contained on the player card to access arcade game credits stored in said database.

A merchant card is provided having a computer readable merchant card medium representing a non-arcade credit value redeemable for goods and services at merchant locations accepting the merchant card. A merchant card interface is provided in communication with the prime computer readable medium for reading and writing to the merchant card. Additionally, in the preferred embodiment, the set of computer readable instructions includes instructions for modifying the computer readable merchant card medium according to the non-arcade credit value so that the merchant card represents the non-arcade credit value according to the arcade game credits represented by the player card.

A merchant balance database is provided in communication with the prime computer readable medium representing a non-arcade credit balance that can be associated with the merchant card. Further, the set of computer readable instructions includes instructions for modifying the computer readable merchant card medium only when the non-arcade credit value to be associated with the merchant card is less than or equal to the non-arcade credit balance of the merchant balance database so that the computer readable instructions cannot associate the non-arcade credit value to the merchant card greater than the non-arcade credit balance of the merchant card balance database. In a further advantageous embodiment, the set of computer readable instructions includes instructions for reducing the amount of the non-arcade credit balance of the merchant balance database when the non-arcade credit value is associated with the merchant card, for requesting an increase in the amount of the non-arcade credit balance of the merchant balance database when the non-arcade credit balance falls below a predetermined level, and for increasing the amount of the non-arcade credit balance of the merchant database when the non-arcade credit falls below a predetermined level.

In operation, the system reads a computer readable player card medium of a player card to determine arcade game credits for actuating the arcade game, determines the arcade game credits from the player card, determines a non-arcade credit value corresponding to the arcade game credits, and, associates the non-arcade credit value with a merchant card so that the player can transfer arcade game credits into non-arcade credit value.

Advantageously, the system can also determine whether the player card includes sufficient arcade game credits for actuating the arcade game. Accordingly, the system removes a predetermined number of credits from the player card upon actuation of the arcade game for play, and adds credits to the player card as a result of the game play.

A merchant card is then provided that has a computer readable merchant card medium representing a non-arcade credit value redeemable for goods and services at merchant locations accepting the merchant card. Once the merchant card is issued, the non-arcade credit value represented by the merchant card is determined to confirm the amount added to the merchant card.

### DETAILED DESCRIPTION OF THE DRAWINGS

This invention is best understood with reference to the following drawings that are referenced herein and incorporated into the specification.

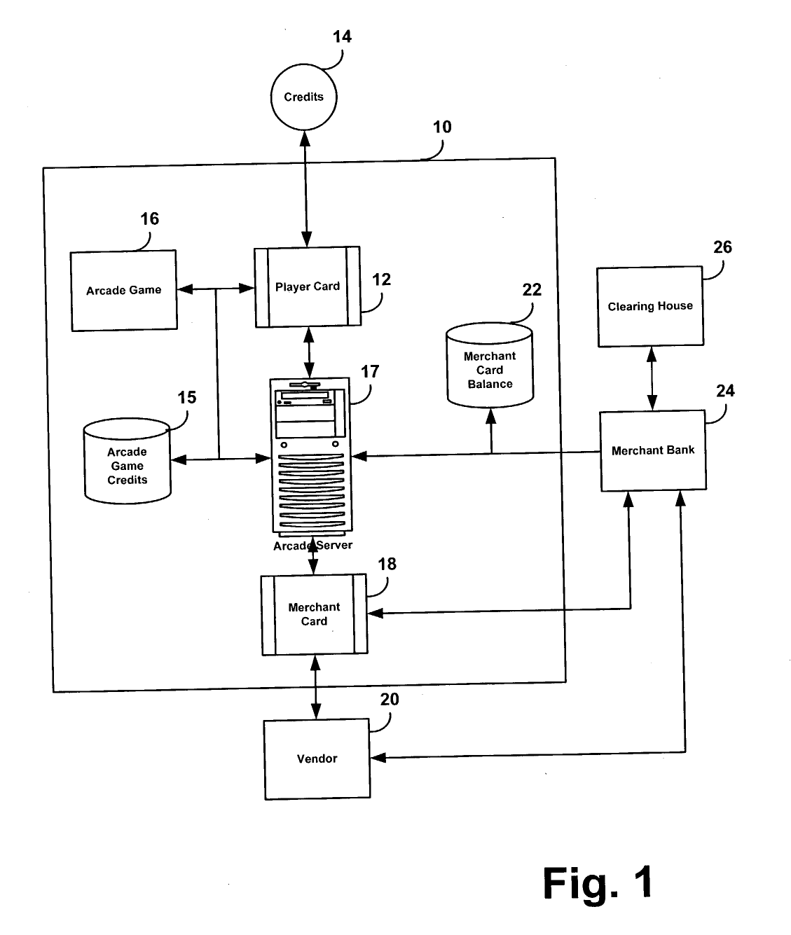

FIG. 1 is a schematic showing the various components of one embodiment of the current invention;

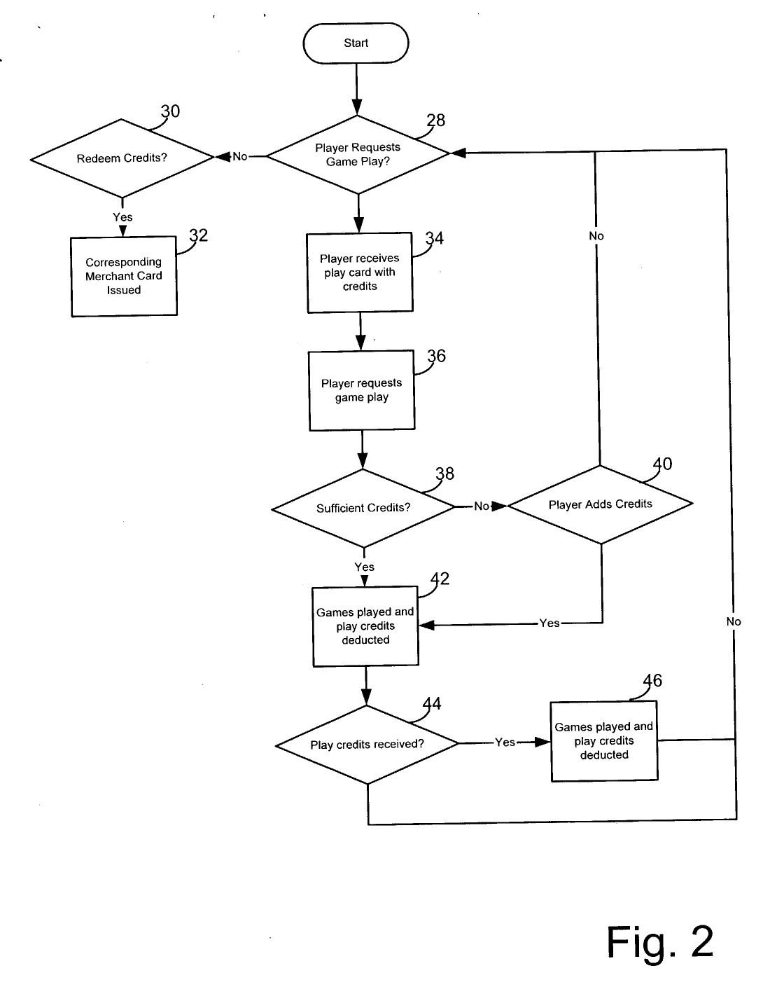

FIG. 2 is a flow chart illustrating the process applied to this invention;

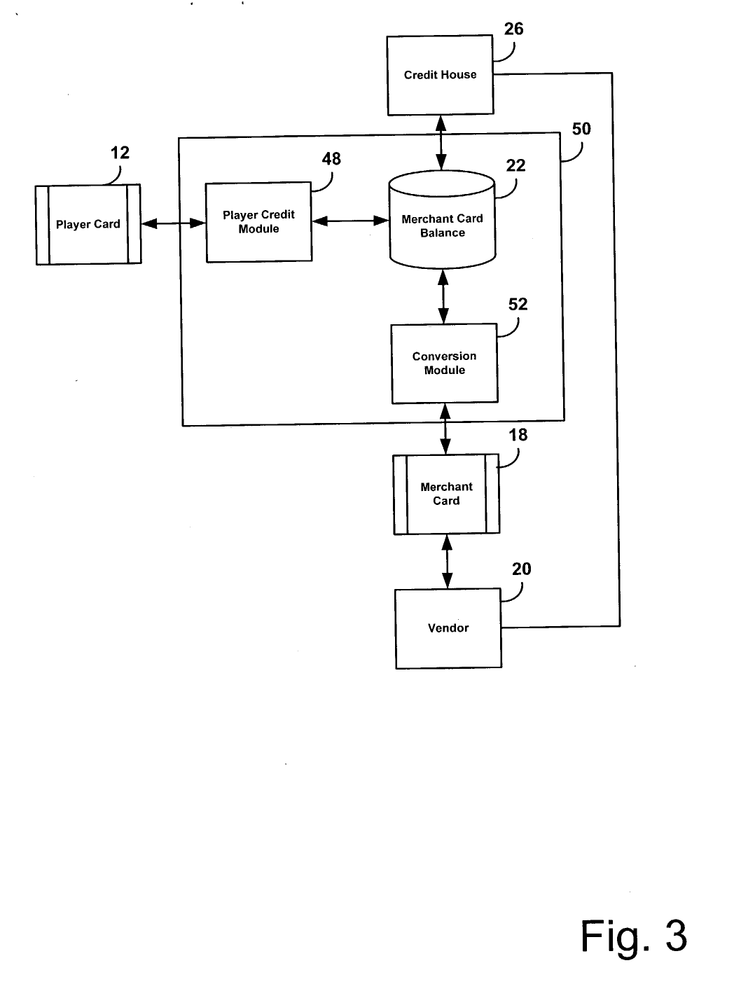

FIG. 3 is a schematic illustrating various components of the invention; and,

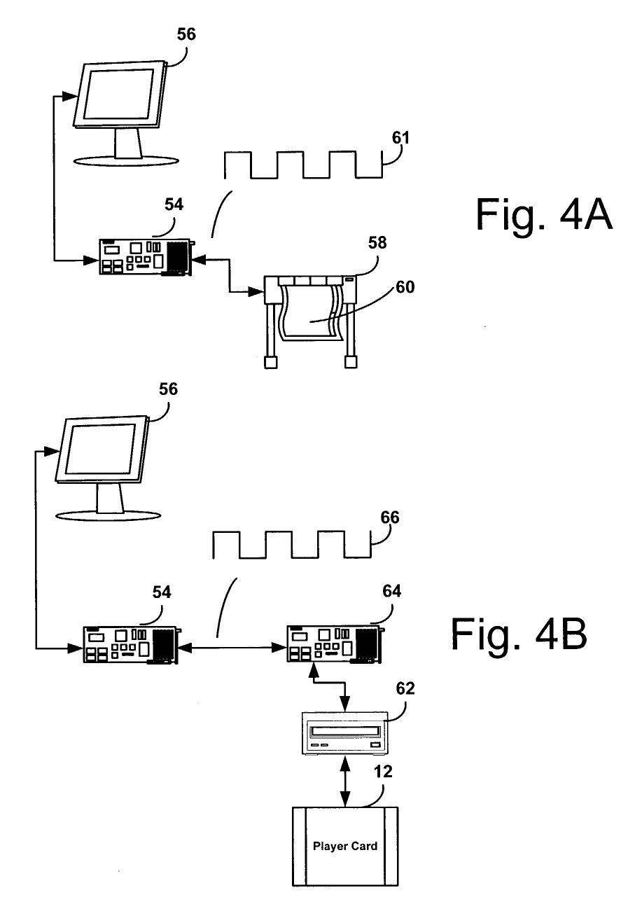

FIGS. 4a and 4b are schematic illustrations of various components of the invention.

### DETAILED DESCRIPTION OF THE INVENTION

The detailed description that follows may be presented in terms of program procedures executed on a computer or network of computers. These procedural descriptions are representations used by those skilled in the art to most effectively convey the substance of their work to others skilled in the art. These procedures herein described are generally a self-consistent sequence of steps leading to a desired result. These steps require physical manipulations of physical quantities such as electrical or magnetic signals capable of being stored, transferred, combined, compared, or otherwise manipulated. An object or module is a section of computer readable code embodied in a computer readable medium that is designed to perform a specific task or tasks. Actual computer or executable code or computer readable code may not be contained within one file or one storage medium but may span several computers or storage mediums. The terms “host,” “server,” and computer may be hardware, software, or combinations of hardware and software that provide the functionality described herein.

The present invention is described below with reference to flowchart illustrations of methods, apparatus (“systems”), and computer program products according to the invention. It will be understood that each block of a flowchart illustration can be implemented by a set of computer readable instructions or code. These computer readable instructions may be loaded onto a general purpose computer, special purpose computer, or other programmable data processing apparatus to produce a machine such that the instructions will execute on a computer or other data processing apparatus to create a means for implementing the functions specified in the flowchart block or blocks.

These computer readable instructions may also be stored in a computer readable medium that can direct a computer or other programmable data processing apparatus to function in a particular manner, such that the instructions stored in a computer readable medium produce an article of manufacture including instruction means that implement the functions specified in the flowchart block or blocks. Computer program instructions may also be loaded onto a computer or other programmable apparatus to produce a computer executed process such that the instructions are executed on the computer or such that other programmable apparatus provide steps for implementing the functions specified in the flowchart block or blocks. Accordingly, elements of the flowchart support combinations of means for performing the special functions, combinations of steps for performing the specified functions, and program instruction means for performing the specified functions. It will be understood that each block of the flowchart illustrations can be implemented by special purpose hardware-based computer systems that perform the specified functions or steps, or combinations of special purpose hardware or computer instructions. The current invention is now described more fully herein with reference to the drawings in which the preferred embodiment of the invention is shown. This invention may, however, be embodied any many different forms and should not be construed as limited to the embodiment set forth herein. Rather, these embodiments are provided so that this disclosure will be thorough and complete and will fully convey the scope of the invention to those skilled in the art.

Referring now to FIG. 1, illustrating one embodiment of the current invention, arcade 10 is the physical location containing the arcade games to be played. Such games can include pinball, card games, arcade games, or any number of other games to be played by a player, preferably in electronic format. To play a game, the arcade game has credits stored on player card 12 issued by the arcade establishment, or player card 12 is operatively associated with an arcade game credit database 15. In the preferred embodiment, arcade game credits 14 are purchased and electronically stored on player card 12 and exhausted as game 16 is played. The points or credits awarded from playing the game can also be shared on the player card. A player card has some form of recordable medium or computer readable medium to record the credits or points awarded to the player. For example, a player may pay $10.00 to receive 40 credits stored on player card 12. Therefore, the player can insert player card 12 into arcade games and receive 40 credits worth of games. One method for recording a number of credits on player card 12 is the use of a magnetic strip that is re-writeable. Another method is to use a chip, smart-card, or other computer readable medium. The strip or computer readable medium records the initial credits and then deducts credits spent for each game played. Another method is to use a computer readable medium allowing information to be recorded and subsequently retrieved, modified, and stored. In addition to exhausting credits as they are used to play a game, a winning outcome may result in the addition of credits to player card 12. For example, if a player reaches a certain score while playing game 16, a predetermined number of credits can be added to player card 12 thereby increasing the number of credits represented by the card. At some point, the player may have a player card with a positive number of credits and may wish to take advantage of theses credits through means other than playing more games.

Advantageously, the player can now translate the arcade game credits accumulated on player card 12 into a merchant card 18. Merchant card 18 is a card is having a predetermined balance acceptable at merchant or vendor 20 and can be used to procure the vendor's goods or service. One example of a merchant card is a VISA® card. Such cards are typically honored at a wide variety of retail stores or banks. Many retailers offer similar types of cards, although these latter cards are typically limited in use to the particular retailer and usually are redeemable only for store merchandise or services at one of the retailer's commercial outlets. It should be noted that a merchant card may allow for “cash advances” or be restricted to purchases only. The player turns in player card 12 to the arcade operator who can then issue a merchant card with a balance having some relation to the credits of player card 12. Alternatively, the arcade operator may provide devices, similar to automated teller machines, at which a player may convert the credit balance of one or more player cards and be issued a corresponding merchant card directly. The arcade operator has available a finite merchant card balance 22 which is procured through merchant bank 24 that is part of clearing house system 26 such as Visa. In this arrangement, when merchant card 18 is issued to a player, a balance on the merchant card is deducted from the merchant card balance 22 and the arcade operator then has a decreased balance from which to issue merchant credits. The balance is derived from merchant bank 24 which provides the arcade operator with a predetermined balance for use with merchant cards. Because merchant bank 24 is part of clearinghouse 26, merchant card 18 is redeemable at any merchant recognizing the clearinghouse. It is understood that a clearinghouse such as Visa has a wide network of retail establishments accepting the merchant card 18, allowing a player to take advantage of the credits earned when playing the game at a wide variety of commercial merchants.

In the preferred embodiment, an arcade server 17 is in communication with player card 12 and/or arcade game 16 through a player card interface, as well as arcade game credits database 15, merchant card 18, and merchant card balance database 22 in order to determine the arcade game credits represented by said player card and associate non-arcade credit value from merchant card balance database 22 onto merchant card 18. Merchant card 18 is in communication with merchant card balance database 22 through a merchant card interface capable of reading and writing to said merchant card. Referring now to FIG. 2, the process of using the invention is described in more detail in the illustrative flowchart. In step 28, the player is asked whether he wishes to play the game. If the player does not, the player is queried as to whether he wishes to redeem the game credits in step 30. If the player responds affirmatively, then the merchant card is issued with a non-arcade credit value corresponding to the arcade game credits represented on player card 12 at step 32. If the player wishes to play the game, the player must use a player card in step 34 and request a game play in step 36. Step 38 represents a query as to whether there are sufficient credits to allow game play and, if not, the player is allowed to add credits to player card 12, or arcade game credit database 15, in step 40. If the player adds credits, or if sufficient credits exist in step 38, the player plays the game in step 42 and the credits are deducted from the player card. In the event that the player is rewarded play credits in step 44, the player credits are added to the player card in step 46. If the player did not receive credits, the player returns to step 28 to request to replay the game or, as described, to request redemption of game credits. Through this process, player credits are removed and added to player card 12 or arcade game credit database 15.

Referring now to FIG. 3, player card 12 is shown interacting with player credit module 48 with computer readable instructions embedded in a computer readable medium. The player credit module, a representation of merchant credit balance 22, and a conversion module 52 comprise a conversion unit 50, which acts as an interface for both player card 12 and merchant card 18. Player credit module 48 determines whether player card 12 has a positive arcade game credit balance that can be converted non-arcade credit value. If so, merchant credit balance 22 is debited according to a formula relating the game credits on player card 12 to a value to be recorded on merchant card 18. The conversion from arcade game credits to non-arcade credit value is accomplished by conversion module 52, and a merchant card 18 is then issued to the player. The merchant card balance 22, as described, is credited through clearinghouse 26. Once merchant card 18 is issued to the player then the merchant card is redeemable at any participating merchant or vendor 20.

Referring now to FIG. 4A, the aspects of this invention required to enable the system of the current invention to be compatible with existing arcade games is further illustrated. An existing arcade game typically includes a processing unit 54 and a display monitor 56. The processing unit contains computer readable instructions embodied in a computer readable medium which, when executed, provide functionality necessary for enjoyment of the arcade game. The playing of the game is presented in a visual format and displayed on monitor 56 as output to the arcade game player. The game can contain anything from card games to flight simulators, and is played through the use of any of a variety of well-known auxiliary devices such as joysticks, keyboards, and the like (not shown). To play the game, it is necessary to insert credits that can be in the form of tokens or currency so that sufficient credits are deposited within the arcade game to allow for the enjoyment of the game. A cash or token receiver 58 is in electronic communication with the computer readable medium processing unit 54. When credits or currency 60 is accepted by the credit or currency acceptor 58, a pulse signal 61 is generated from the bill acceptor informing the processing unit the number of credits or currency that was inserted into the arcade game. The pulse transmitted from the bill acceptor to the processing unit, while taking any of a variety of forms known to those of skill in the art, has primarily two properties which need to be known by the processing unit. First, the processing unit needs to know what the pulse represents. For example, the pulse could represent a penny, $0.25, $0.50, or a dollar. Secondly, the processing unit needs to know the number of pulses transmitted from the bill acceptor to the processing unit. For example, if a pulse represented $0.25, then the acceptance of a dollar would result in four pulses. In this example, one pulse would represent $0.25, while a dollar would cause a multiplier of four to be actuated, thereby informing the processing unit that a dollar had been accepted and can be credited toward the game, allowing the arcade game player enjoyment of the arcade game.

The typical arcade machine described above can be converted relatively easily and inexpensively to utilize the system of the current invention. The retrofitting includes various components that will allow use of a player card as described above. The use of a player card is embodied in FIG. 4B, wherein player card 12 is inserted into player card interface 62 comprising a card reader. The player card interface reads player card 12 to determine the number of credits represented by the player card. This is performed by card reader computer readable medium and a card reader processor 64. The card reader processor then converts the credits read from the player card into pulse 66 which is then provided to processing unit 54 of the arcade game. This way, player card 12 and card reader 62 can be retrofitted to existing arcade games without the necessity of re-engineering the method in which the processing unit of the arcade game accounts for credits. Then, the card reader need only know the pulse quantity and multiplier to convert the credits on the card to the pulse to be recognized by the processing unit of the arcade game. It is advantageous to be able to retrofit the card reader in existing arcade games without having to reprogram the way in which the arcade game accounts for credits. Card reader processor 64 can be connected to the arcade game such that it can determine the credits awarded by play of the game, and in turn direct the card reader 62 to write the net credits to player card 12 for eventual redemption of the total credits thereon.

This invention is implemented through computer readable medium containing computer readable instructions which contains a credit player module, credit card balance, and conversion module bearing computer readable medium. A player card interface and merchant card interface are also provided in communication with the computer readable medium. The player card contains computer readable and writable medium which can represent the player credits both deducted when playing the game as to well as added when awarded by a game. These credits can be read by the player credit module and converted by the conversion module to a merchant card. The merchant card can represent the card balance according to the credits of the player card and the computer readable medium of the merchant card can be read by the interface device by reading the merchant card so that the balance is recorded on the card. Once the is balance is recorded on a readable medium of the merchant card, the card can be redeemed at a participating merchant.

In many jurisdictions, laws are amended and changed so that the arcade games which have previously been enjoyed are no longer allowed. Therefore, the arcade game manufacturers and arcade game distributors have large numbers of arcade games for which there is no market. These arcade games, while previously allowed by accepting money and handing out money, now cannot be used in these jurisdictions. The current invention allows these existing arcade games to be retrofitted with the player card system rather than currency, thereby allowing the manufacturers or the distributors to place these arcade games back into the market.

While a preferred embodiment of the invention has been described using specific

What is claimed is:

1. A system for rewarding a player of an arcade game comprising:
a player card having a computer readable player card medium representing arcade game credits for actuating said arcade game;
a player card interface for receiving said player card;
said player card interface adapted for reading said computer readable player card medium representing said arcade game credits;
a prime computer readable medium in communication with said player card interface;
a set of computer readable instructions embodied in said prime computer readable medium for:
reading said player card medium with said player card interface,
determining said arcade game credits represented by said player card according to said player card medium,
determining a non-arcade credit value corresponding to said arcade game credits, and,
associating said non-arcade credit value with a merchant card so that said player can transfer arcade game credits into non-arcade credit values.

2. The system of claim 1 wherein said set of computer readable instructions include instructions for determining whether said player card represents sufficient arcade game credits for actuating said arcade game.

3. The system of claim 2 wherein said set of computer readable instructions include instructions for reducing the number of credits represented by said player card by a predetermined number upon actuation of said arcade game for play.

4. The system of claim 2 wherein said set of computer readable instructions include instructions for increasing the number of credits represented by said player card by a predetermined amount according to said game play.

5. The system of claim 1 wherein said set of computer readable instructions include instructions for directing said player card interface to write to said computer readable player card medium so that said arcade game credits can be added to said player card.

6. The system of claim 1 including a merchant card having a computer readable merchant card medium representing a non-arcade credit value redeemable for goods and services at vendor locations accepting said merchant card.

7. The system of claim 6 including:
a merchant card interface in communication with said prime computer readable medium for reading and writing to said merchant card; and,
said set of computer readable instructions including instructions for modifying said computer readable merchant card medium according to said non-arcade credit value so that said merchant card represents said non-arcade credit value according to said arcade game credits represented by said player card.

8. The system of claim 1 including:
a merchant balance database in communication with said prime computer readable medium representing a non-arcade credit balance that can be associated with said merchant card;
said set of computer readable instructions including instructions for modifying said computer readable merchant card medium only when said non-arcade credit value to be associated with said merchant card is less than or equal to said non-arcade credit balance of said merchant balance database so that said computer readable instructions cannot associate said non-arcade credit value to said merchant card greater than the non-arcade credit balance of said merchant card balance database.

9. The system of claim 8 wherein said set of computer readable instructions include instructions for reducing the amount of said non-arcade credit balance of said merchant balance database when said non-arcade credit value is associated with said merchant card.

10. The system of claim 9 wherein said computer readable instructions include instructions for requesting an increase in the amount of said non-arcade credit balance of said merchant balance database when said non-arcade credit balance falls below a predetermined level.

11. The system of claim 9 wherein said computer readable instructions include instructions for increasing the amount of said non-arcade credit balance of said merchant database when said non-arcade credit falls below a predetermined level.

12. A method for rewarding a player of an arcade game with non-arcade credit comprising the steps of:
reading a computer readable player card medium of a player card to determine arcade game credits for actuating said arcade game;
determining said arcade game credits from said player card;
determining a non-arcade credit value corresponding to said arcade game credits; and,
associating said non-arcade credit value with a merchant card so that said player can transfer arcade game credits into non-arcade credit value.

13. The method of claim 12 including the step of determining whether said player card includes sufficient arcade game credits for actuating said arcade game.

14. The method of claim 12 including the step of removing a predetermined number of credits from said player card upon actuation of said arcade game for play.

15. The method of claim 12 including the step of adding credits to said player card as a result of said game play.

16. The method of claim 12 including the step of providing a merchant card having a computer readable merchant card medium representing a non-arcade credit value redeemable for goods and services at vendor locations accepting said merchant card.

17. The method of claim 12 including the step of determining said non-arcade credit value represented by said merchant card.

18. A system for rewarding a player of an arcade game, using a player card having player card information, comprising:
a computer readable medium;
a database contained within said computer readable medium representing arcade game credits accessible via said player card information; and,
a set of computer readable instructions contained within said computer readable medium for retrieving arcade game credits from said database according to said player card information of said player card, associating said arcade game credits with a non-arcade credit value, issuing a merchant card representing said non-arcade credit value so that said player can transfer said arcade game credits to a non-arcade merchant credit value.

19. The system of claim 18 including:
a second database representing a non-arcade credit balance that can be used to issue a merchant card; and,
said set of computer readable instructions include instructions for determining if a sufficient non-arcade credit balance exists in said second database prior to issuing said merchant card.

20. The system of claim 19 wherein said set of computer readable instructions include instructions for reducing the amount of non-arcade credit balance of said second database when said non-arcade credit value is associated with said merchant card.

21. The system of claim 20 wherein said computer readable instructions include instructions for requesting an increase in the amount of said non-arcade credit balance of said second database when said non-arcade credit balance falls below a predetermined level.

22. The system of claim 21 wherein said computer readable instructions include instructions for increasing the amount of said non-arcade credit balance of said second database when said non-arcade credit falls below a predetermined level.
